(19) United States
(12) Patent Application Publication
(10) Pub. No.: US 2014/0020555 A1
(43) Pub. Date: Jan. 23, 2014

(54) PISTON ASSEMBLY FOR ALTERNATIVE COMPRESSOR

(71) Applicant: Marcio Silverio, Joinville, SC (US)

(72) Inventor: Marcio Silverio, Joinville, SC (US)

(21) Appl. No.: 13/976,767

(22) PCT Filed: Dec. 8, 2011
(86) PCT No.: PCT/BR2011/000460

§ 371 Date: Sep. 23, 2013

(30) Foreign Application Priority Data
Dec. 27, 2010 (BR) PII009955-7

(51) Int. Cl. F16J 1/00

(52) U.S. Cl. CPC F16J 1/00
USPC 92/169.1

(57) ABSTRACT

The present invention refers to a piston/cylinder assembly for alternative compressor, wherein the piston performs a reciprocating movement inside the cylinder, wherein piston surface (1) and cylinder surface have a surface roughness parameter Rpk of less than about 60 nm and a surface roughness parameter Rvk of less than 100 nm; and said piston surface (1) receives a coating comprising at least a support layer 2 and at least a DLC layer (3).

### FIELD OF THE INVENTION

The present invention refers to a piston/cylinder assembly for alternative compressors, and, more specifically, to a piston/cylinder assembly for linear compressors.

### BACKGROUND OF THE INVENTION

The function of a compressor is to elevate the pressure of determined volume of fluid to a pressure required to effect a refrigeration cycle. The thus called alternative compressors, where a piston reciprocately slides inside a cylinder to carry out compression of gases, are known from the art.

A contact between a reciprocating piston and a cylinder can generate high mechanical losses, and may cause damage and premature failure in a compressor. Furthermore, such a contact between parts may increase noise, operational temperature, compressor vibration, and loss of effectiveness, thus also contributing to increase in equipment energy power consumption.

In some types of compressors, a lubricating oil between the moving parts is predicted; nevertheless, in some applications to linear compressors the presence of oil is deleterious.

In an attempt to solve this problem related to a piston/cylinder friction without using lubricating oil, some technical solutions have been developed for using special coatings in such parts.

This is, for example, the case of solutions disclosed in U.S. Pat. No. 6,641,337 and JP 2001107860, which refer to application of DLC (Diamond-like Carbon) to moving parts of a compressor.

However, even these already known solutions do not entirely solve the problem of stress contact and consequent wear between parts, since the concentration of contact stresses over harsh peaks of DLC ends up causing premature wear of the coating.

### OBJECTS OF THE INVENTION

Therefore, an object of the present invention relates to a piston/cylinder assembly for an alternative compressor, which provides lesser friction between the piston and cylinder, thus preventing premature wear of the parts.

### SUMMARY OF THE INVENTION

The present invention achieves the objects mentioned above by providing a piston/cylinder assembly for an alternative compressor where said piston performs a reciprocating movement inside said cylinder, where piston surface and cylinder surface comprise a surface roughness with surface roughness parameter Rpk of less than about 60 and a surface roughness parameter Rvk of less than 100 nm; and the piston surface receives a coating comprising at least one support layer and at least one DLC layer (3).

In a preferred embodiment of the present invention, the cylinder material comprises stainless steel, the support layer material is selected from nitrides and sulfides, and the DLC layer material is selected from non-hydrogenated amorphous carbon, hydrogenated amorphous carbon, non-hydrogenated tetragonal amorphous carbon, and hydrogenated tetragonal amorphous carbon. Said DLC layer may further comprise metal and non-metal alloy elements.

### BRIEF DESCRIPTION OF THE DRAWINGS

FIG. 1 illustrates a schematic view of the coating of the piston/cylinder assembly in accordance with a preferred embodiment of the present invention.

FIG. 2 illustrates a comparative graphic representation between the present invention and the solution of the state of the art.

FIG. 3 illustrates a schematic representation of the coated surfaces of the piston/cylinder assembly in accordance with the preferred embodiment of the present invention.

### DETAILED DESCRIPTION OF THE INVENTION

Next, the present invention will be described in more details based on execution examples represented by the appended drawings.

In order to ensure the correct functioning of the piston/cylinder assembly without affecting the effectiveness in function of wear and in the absence of lubrication by lubricating oil, the present invention provides for coating the outer surface of the piston with thin films of DLC in association with a base coating that increases the mechanical strength of the DLC coating applied to the surface.

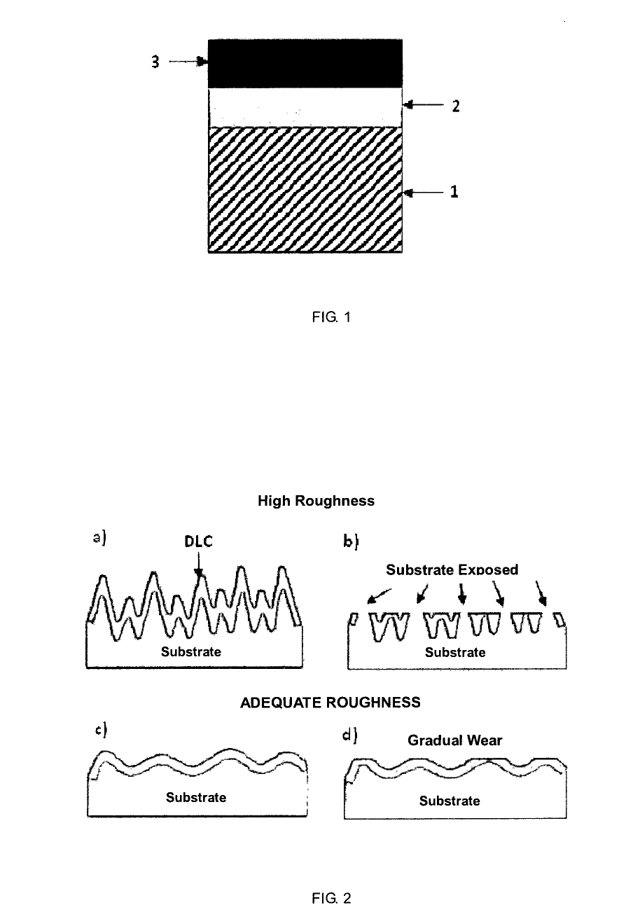

Thus, as can be seen from FIG. 1, the present invention comprises a piston 1 (only a portion of its outer surface is illustrated) which receives a coating preferably composed of a mechanical support layer 2 and a DLC layer 3. In the preferred embodiment of the present invention, the support layer 2 and support layer 3 generate a coating having a thickness of approximately 3-10 microns.

Said support layer 2 can comprise a single or multiple elements disposed in the following forms: gradually variable chemical composition, constant chemical composition, monolayer or multilayer.

In addition, the composition of support layer 2 can vary in accordance with mechanical tensiles of a specific design of a piston/cylinder assembly, wherein said layer can comprise nitrides (CrN, FeN, TiN, AlTiN, CAlTiN, etc.), sulfides (MoS₂, and variations, WS₂, and variations, etc.; and other coatings having intermediate hardness between the substrate and DLC in order to give mechanical support to high loads acting on the piston.

With regard to the DLC 3 layer, same is composed of a carbon-based coating having variable proportions of hydrogen, and it may also contain the following variations: a-C:H (Non-Hydrogenated Amorphous Carbon); a-C:H (Hydrogenated Amorphous Carbon); ta-C (Non-Hydrogenate Tetragonal Amorphous Carbon); ta-C:H (Hydrogenated Tetragonal Amorphous Carbon). Besides these variations, addition of alloy elements can also be used to obtain specific properties for each application, wherein a layer with addition of alloy elements is designated Me-DCL, wherein Me refers to the (metal or non-metal) added elements.

The disposition of layer 3 can also comprise variations concerning the proportion of alloy elements, and can be, for example: a gradually variable chemical composition, a constant chemical composition, a monocompound, or DLC variations disposed in intercalated form.

Application of the DLC layer is carried out after preparing the piston surface that will receive said layer. This preparation involves a surface finishing process so as to obtain a surface roughness with parameters Rpk<60 nm and Rvk<100 nm obtained by topographic measurement of the surfaces.

To ensure the reduction of the friction on the piston/cylinder assembly, the cylinder surface is prepared so as to obtain a cylinder surface with surface roughness having parameters Rpk<60 nm and Rvk<100 nm achieved by topographical measurement of the surfaces.

In this sense, FIG. 2 schematically shows the wear of DLC layer on a surface without the roughness specified above (Figures a) and b)) and with the roughness specified above (Figures c) and d)).

As can be seen from Figures a) and b), under high roughness condition, DLC layers undergoes a premature wear due to the concentration of contact stresses in the surface harsh peaks (that is, they end up forming punctual support areas on the layer). Such a premature wear then leaves the piston substrate exposed.

Nevertheless, when the roughness is within the parameters proposed by the present invention—such as shown in Figures c) and d), a gradual and mild wear on the DLC layer occurs due to the formation of a greater area of support between the surfaces resulting in the reduction of contact stresses.

In the preferred embodiment of the present invention, said piston/cylinder assembly is made of stainless steel.

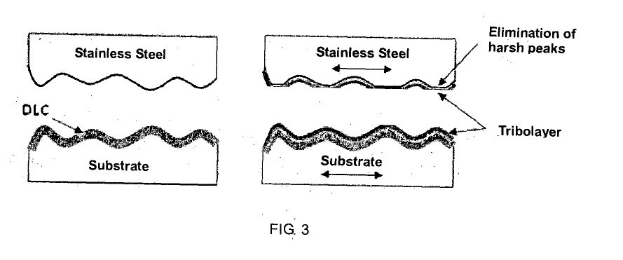

As can be seen from FIG. 3, the use of a stainless steel cylinder allows for a tribolayer formation uniformly distributed at both contact interfaces due to the relative movement between the parts. Said tribolayer is formed due to the elimination (by mild wear) of harsh peaks from the stainless steel of the cylinder and of DLC as well as residues of materials used in the remaining parts of the compressor and the atmosphere application thereof.

Therefore, the formation of a longer lasting DLC coating by fabricating one of the parts of the piston/cylinder assembly ensures the formation of a tribolayer, which is essential for the functioning of the tribologic pair, allowing for the piston/cylinder assembly to function without significant wear, low friction and suitable durability.

It should be construed that this description based on the figures above only refers to one of the possible embodiments of the object of the present invention, wherein the real scope of the object to be protected is defined by the appended claims.

1. Piston/cylinder assembly for an alternative compressor wherein the piston performs a reciprocating movement inside the cylinder, characterized in that:
piston surface (1) and cylinder surface have a surface roughness parameter Rpk of less than about 60 nm and a surface roughness parameter Rvk of less than 100 nm;
said piston surface (1) receives a coating comprising at least a support layer 2 and at least a DLC layer (3).

2. Piston/cylinder assembly, in accordance with claim 1, characterized in that the cylinder material is stainless steel.

3. Piston/cylinder assembly, in accordance with claim 1 or 2, characterized in that the material of said support layer (2) is selected from nitrides and sulfides.

4. Piston/cylinder assembly, in accordance with claim 1, 2, or 3, characterized in that the material of said DLC layer (3) is selected from non-hydrogenated amorphous carbon, hydrogenated amorphous carbon, non-hydrogenated tetragonal amorphous carbon, and hydrogenated tetragonal amorphous carbon, or a combination thereof.

5. Piston/cylinder assembly, in accordance with claim 4, characterized in that said DLC layer (3) further comprises metal or non-metal alloy elements.
